(19) United States
(12) Patent Application Publication
(10) Pub. No.: US 2004/0047604 A1
(43) Pub. Date: Mar. 11, 2004

(54) Recording medium having data structure for managing reproduction of a data stream having a packet encoding time stamp recorded thereon and recording and reproducing methods and apparatuses

(76) Inventors: Kang Soo Seo, Kyunggi-do (KR); Sung Wan Park, Suwon-si (KR); Byung Jin Kim, Kyunggi-do (KR); Soung Hyun Um, Kyunggi-do (KR)

Correspondence Address: HARNESS, DICKEY & PIERCE, P.L.C., P.O. BOX 8910, RESTON, VA, 20195, US

(21) Appl. No.: 10/614,050

(22) Filed: Jul. 8, 2003

(30) Foreign Application Priority Data
Jul. 9, 2002 (KR) 2002-39806

(51) Int. Cl. H04N 5/781

(52) U.S. Cl. 386/95; 386/125

(57) ABSTRACT

A recording medium having a data structure for managing video data recorded on the recording medium. The data structure having multiple data packets recorded on the recording medium with time control information areas. The time control information areas including decoding time interval information. The time control information areas recorded at a fixed time interval in a corresponding one of said plurality of data packets.

### BACKGROUND OF THE INVENTION

1. Field of the Invention

A recording medium having a data structure for managing video data recorded on the recording medium. The data structure having multiple data packets recorded on the recording medium with time control information areas. The time control information areas including decoding time interval information. The time control information areas recorded at a fixed time interval in a corresponding one of a plurality of data packets.

2. Description of the Related Art

The standardization of new high-density read only and rewritable optical disks capable of recording large amounts of high-quality video and audio data has been progressing rapidly and new optical disk related products are expected to be commercially available on the market in the near future. The Blu-ray Disc Rewritable (BD-RW) is one example of these new optical disks.

FIG. 1 illustrates the file structure of the BD-RW. The file structure or data structure provides for managing the reproduction of the video and audio data recorded on the BD-RW. As shown, the data structure includes a root directory that contains at least one BDAV directory. The BDAV directory includes files such as ‘info.bdav’, ‘menu.tidx’, and ‘mark.tidx’, a PLAYLIST subdirectory in which playlist files (*.rpls and *.vpls) are stored, a CLIPINF subdirectory in which clip information files (*.clpi) are stored, and a STREAM subdirectory in which MPEG2-formatted A/V stream clip files (*.m2ts) corresponding to the clip information files are stored. In addition to illustrating the data structure of the optical disk, FIG. 1 represents the areas of the optical disk. For example, the general information file info.bdav is stored in a general information area or areas on the optical disk.

Because the BD-RW data structure and disk format as illustrated in FIG. 1 is well-known and readily available, only a brief overview of the file structure will be provided in this disclosure.

As alluded to above, the STREAM directory includes MPEG2-formatted A/V stream files called clips. The STREAM directory may also include a special type of clip referred to as a bridge-clip A/V stream file. A bridge-clip is used for making seamless connection between two or more presentation intervals selected in the clips, and generally have a small data size compared to the clips. The A/V stream includes source packets of video and audio data. For example, a source packet of video data includes a header and a transport packet. A source packet includes a source packet number, which is generally a sequentially assigned number that serves as an address for accessing the source packet. Transport packets include a packet identifier (PID). The PID identifies the sequence of transport packets to which a transport packet belongs. Each transport packet in the sequence will have the same PID.

The CLIPINF directory includes a clip information file associated with each A/V stream file. The clip information file indicates, among other things, the type of A/V stream associated therewith, sequence information, program information and timing information. The sequence information describes the arrival time basis (ATC) and system time basis (STC) sequences. For example, the sequence information indicates, among other things, the number of sequences, the beginning and ending time information for each sequence, the address of the first source packet in each sequence and the PID of the transport packets in each sequence. A sequence of source packets in which the contents of a program is constant is called a program sequence. The program information indicates, among other things, the number of program sequences, the starting address for each program sequence, and the PID(s) of transport packets in a program sequence.

The timing information is referred to as characteristic point information (CPI). One form of CPI is the entry point (EP) map. The EP map maps a presentation time stamp (e.g., on an arrival time basis (ATC) and/or a system time basis (STC)) to a source packet address (i.e., source packet number).

The PLAYLIST directory includes one or more playlist files. The concept of a playlist has been introduced to promote ease of editing/assembling clips for playback. A playlist file is a collection of playing intervals in the clips. Each playing interval is referred to as a playitem. The playlist file, among other things, identifies each playitem forming the playlist, and each playitem, among other things, is a pair of IN-point and OUT-point that point to positions on a time axis of the clip (e.g., presentation time stamps on an ATC or STC basis). Expressed another way, the playlist file identifies playitems, each playitem points to a clip or portion thereof and identifies the clip information file associated with the clip. The clip information file is used, among other things, to map the playitems to the clip of source packets.

A playlist directory may include real playlists (*.rpls) and virtual playlists (*.vpls). A real playlist can only use clips and not bridge-clips. Namely, the real playlist is considered as referring to parts of clips, and therefore, conceptually considered equivalent in disk space to the referred to parts of the clips. A virtual playlist can use both clips and bridge-clips, and therefore, the conceptual considerations of a real playlist do not exist with virtual playlists.

The info.bdav file is a general information file that provides general information for managing the reproduction of the A/V stream recorded on the optical disk. More specifically, the info.bdav file includes, among other things, a table of playlists that identifies the files names of the playlist in the PLAYLIST directory of the same BDAV directory.

The menu.tidx, menu.tdtl and menu.tdt2 files store information related to menu thumbnails. The mark.tidx, mark.tdtl and mark.tdt2 files store information that relates to mark thumbnails. Because these files are not particularly relevant to the present invention, they will not be discussed further.

The standardization for high-density read-only optical disks such as the Blu-ray ROM (BD-ROM) is still under way. An effective data structure for managing reproduction of video and audio data recorded on the high-density read-only optical disk such as a BD-ROM is not yet available.

FIG. 2 illustrates the schematic of an optical disc apparatus for recording data in a BD-RW or for playing a data stream. The system includes a Video Disc Recorder (hereinafter referred to simply to as VDR) having a light pickup 11 for recording data into a BD-RW 10 or for playing the data from the same; a VDR system 12; and an encoder 13.

In the VDR system 12, a data stream is recorded in the BD-RW using a data structure of a fixed recording size as shown in FIG. 3. More specifically, the data stream is recorded as a series of Transport Packets in MPEG2 form, which has a recording size of 188 bytes. The TP is recorded as a Source Packet that has a recording size of 192 bytes, which includes a transport packet of 188 bytes and a 4 byte header. An aligned unit has a recording size of 6144 bytes and contains 32 source packets.

An arrival time stamp (hereinafter referred to simply to as ATS) of the TP is recorded in the header information, of a recording side of 30 bits. When encoding A/V data, the ATS is used to maintain the time interval between each TP. And when decoding, the ATS can prevent problems, such as Buffer Overflow or Buffer Underflow, that arise from decoding timing discrepancy between packets, in advance.

When A/V data stream is transmitted through a digital interface, such as IEEE 1394, the ATS is needed for processing a normal decoding operation in an auxiliary device; and additionally, the ATS can reduce the system buffer size.

Development and standardization processes for high-density read-only optical discs, such as BD-ROM, are currently in progress, and the corresponding products are expected to be introduced.

### SUMMARY OF THE INVENTION

The invention is directed to a recording medium having a data structure for managing video data recorded on the recording medium. The data structure having a plurality of data packets recorded on the recording medium. Each of the packets having a plurality of time control information areas, representing decoding time interval information. Each of the time control information areas recorded at a fixed time interval in a corresponding one of said plurality of data packets.

The invention is further directed to a recording medium having a data structure for managing video data recorded on the recording medium. The data structure having a plurality of data packets recorded on the recording medium. Each of the packets having a plurality of time control information areas, representing decoding time interval information. Each of the time control information areas recorded at a fixed recording interval in a corresponding one of said plurality of data packets.

The invention is further directed to a recording medium having a data structure for managing video data recorded on the recording medium. The data structure having a plurality of data packets recorded on the recording medium. Each of the packets having a plurality of time control information areas, representing decoding time interval information. Each of the time control information areas recorded in various predetermined recording area in a corresponding one of said plurality of data packets.

### BRIEF DESCRIPTION OF THE DRAWINGS

The accompanying drawings, which are included to provide further understanding of the invention, illustrate the preferred embodiments of the invention, and together with the description, serve to explain the principles of the present invention.

FIG. 1 illustrates the prior art file or data structure of a rewritable optical disk according to the Blu-Ray Disc Rewritable (BD-RW) standard;

FIG. 2 illustrates a schematic diagram of an optical recording and reproduction device;

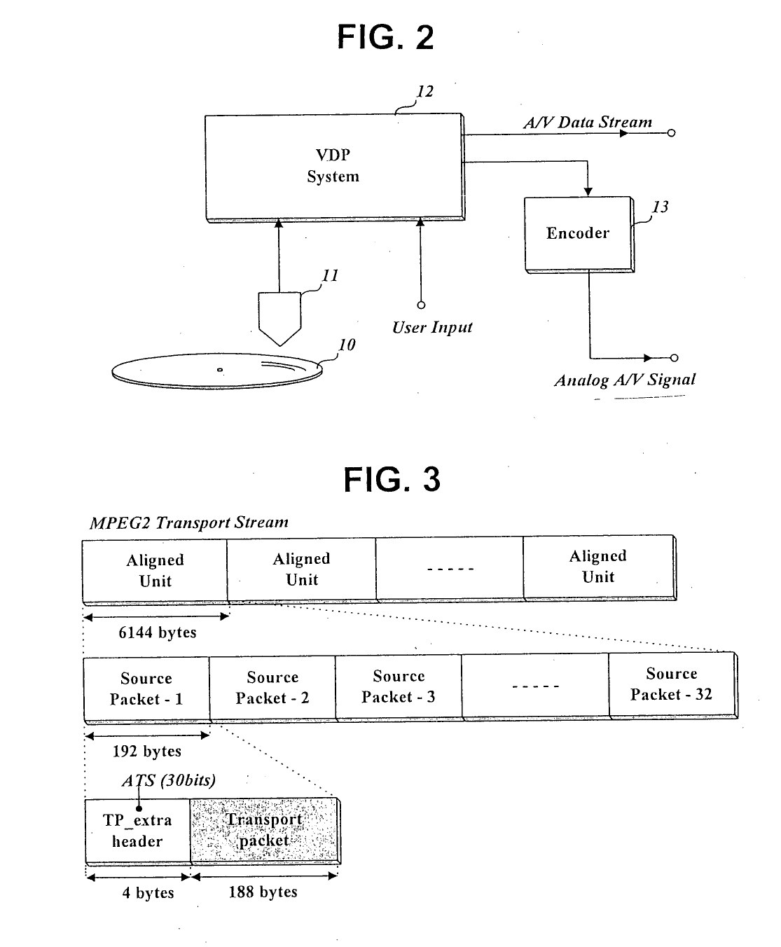

FIG. 3 illustrates an MPEG2 Transport Stream used in recording data blocks on an optical recording medium;

FIG. 4 illustrates a data structure of a first embodiment according to the present invention;

FIG. 5 illustrates a block diagram of an optical disc apparatus, such as a VDP;

FIGS. 6 through 9 illustrate exemplary embodiments of a data structure having a packet encoding time stamp in accordance with the present invention; and

FIGS. 10 through 12 illustrate exemplary embodiments of a data structure having a packet encoding time stamp in accordance with the present invention.

### DESCRIPTION OF THE PREFERRED EMBODIMENTS

In order that the invention may be fully understood, a preferred embodiment thereof will now be described with reference to the accompanying drawings.

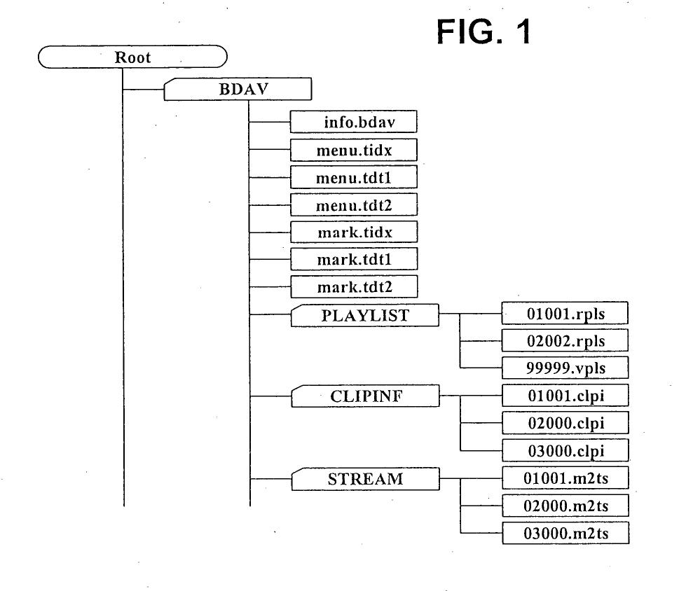

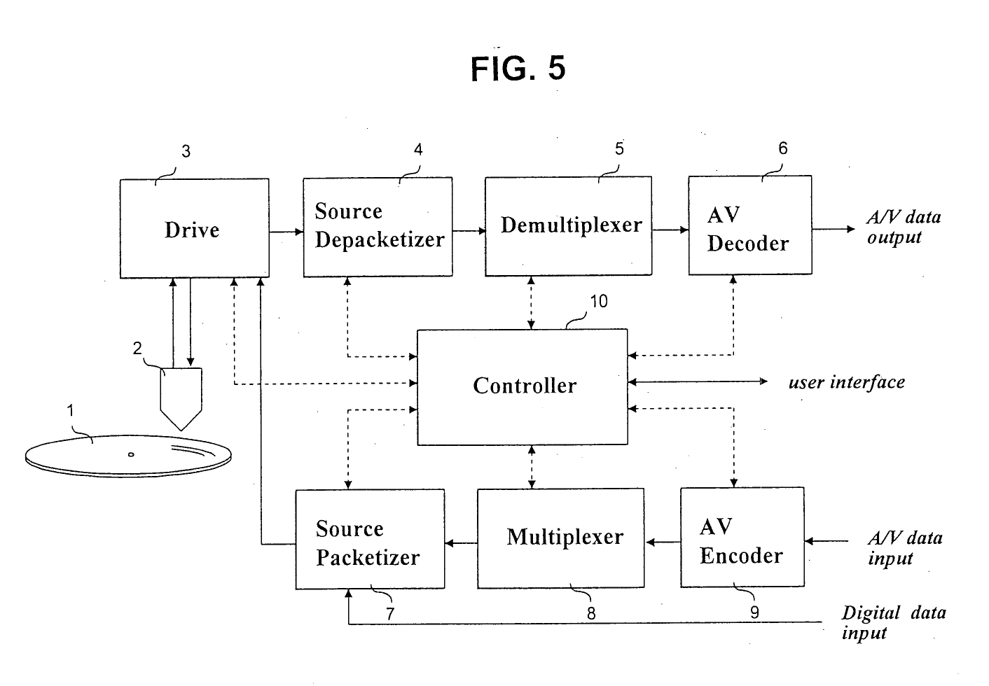

A high-density optical disk, for example, a Blu-Ray ROM (BD-ROM) in accordance with the invention may have a file or data structure for managing reproduction of video and audio data as shown in FIG. 4. Many aspects of the data structure according to the present invention shown in FIG. 4 are similar to that of the BD-RW standard discussed with respect to FIG. 1. As such these aspects will not be described in great detail.

As shown in FIG. 4, the root directory contains at least one DVP directory. The DVP directory includes a general information file info.dvp, menu files menu.tidx, menu.tdtl among others, a PLAYLIST directory in which playlist files (e.g., real (*.rpls) and virtual (*.vpls)) are stored, a CLIPINF directory in which clip information files (*.clpi) are stored, and a STREAM directory in which MPEG2-formatted A/V stream clip files (*.m2ts), corresponding to the clip information files, are stored.

The STREAM directory includes MPEG2-formatted A/V stream files called clips. The STREAM directory may also include a special type of clip referred to as a bridge-clip A/V stream file. A bridge-clip is used for making seamless connection between two or more presentation intervals selected in the clips, and generally have a small data size compared to the clips. The A/V stream includes source packets of video and audio data. For example, a source packet of video data includes a header and a transport packet. A source packet includes a source packet number, which is generally a sequentially assigned number that serves as an address for accessing the source packet. Transport packets include a packet identifier (PID). The PID identifies the sequence of transport packets to which a transport packet belongs. Each transport packet in the sequence will have the same PID.

The CLIPINF directory includes a clip information file associated with each A/V stream file. The clip information file indicates, among other things, the type of A/V stream associated therewith, sequence information, program information and timing information. The sequence information describes the arrival time basis (ATC) and system time basis (STC) sequences. For example, the sequence information indicates, among other things, the number of sequences, the beginning and ending time information for each sequence, the address of the first source packet in each sequence and the PID of the transport packets in each sequence. A sequence of source packets in which the contents of a program is constant is called a program sequence. The program information indicates, among other things, the number of program sequences, the starting address for each program sequence, and the PID(s) of transport packets in a program sequence.

The timing information is referred to as characteristic point information (CPI). One form of CPI is the entry point (EP) map. The EP map maps a presentation time stamp (e.g., on an arrival time basis (ATC) and/or a system time basis (STC)) to a source packet address (i.e., source packet number).

The PLAYLIST directory includes one or more playlist files. The concept of a playlist has been introduced to promote ease of editing/assembling clips for playback. A playlist file is a collection of playing intervals in the clips. Each playing interval is referred to as a playitem. The playlist file, among other things, identifies each playitem forming the playlist, and each playitem, among other things, is a pair of IN-point and OUT-point that point to positions on a time axis of the clip (e.g., presentation time stamps on an ATC or STC basis). Expressed another way, the playlist file identifies playitems, each playitem points to a clip or portion thereof and identifies the clip information file associated with the clip. The clip information file is used, among other things, to map the playitems to the clip of source packets.

A playlist directory may include real playlists (*.rpls) and virtual playlists (*.vpls). A real playlist can only use clips and not bridge-clips. Namely, the real playlist is considered as referring to parts of clips, and therefore, conceptually considered equivalent in disk space to the referred to parts of the clips. A virtual playlist can use both clips and bridge-clips, and therefore, the conceptual considerations of a real playlist do not exist with virtual playlists.

The info.dvp file is a general information file that provides general information for managing the reproduction of the A/V streams recorded on the optical disk. More specifically, the info.dvp file includes, among other things, a table of playlists that identifies the file names of the playlists in the PLAYLIST directory. The info.dvp file will be discussed in greater detail below with respect to the embodiments of the present invention.

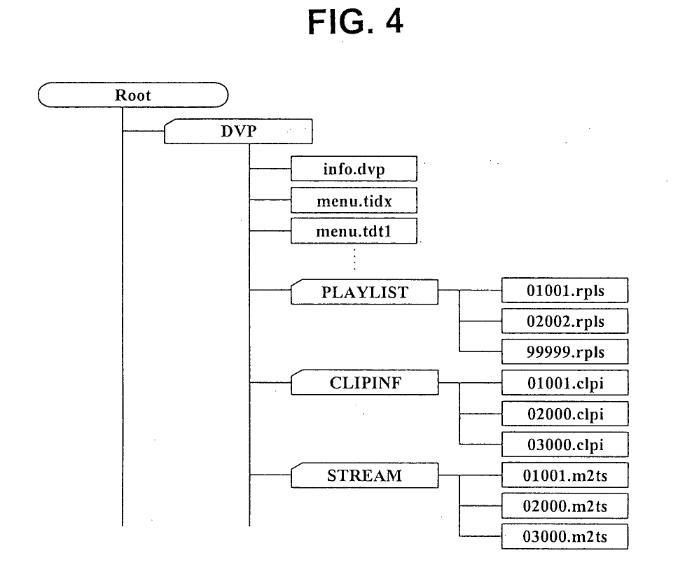

In addition to illustrating the data structure of the recording medium according to an embodiment of the present invention, FIG. 3 represents the areas of the recording medium. For example, the general information file is recorded in one or more general information areas, the playlist directory is recorded in one or more playlist directory areas, each playlist in a playlist directory is recorded in one or more playlist areas of the recording medium, etc.

Video and audio data are typically organized as individual titles; for example, different movies represented by the video and audio data are organized as different titles. Furthermore, a title may be organized into individual chapters in much the same way a book is often organized into chapters.

Because of the large storage capacity of the newer, high-density recording media such as BD-ROM optical disks, different titles, various versions of a title or portions of a title may be recorded, and therefore, reproduced from the recording media. For example, video data representing different camera angles may be recorded on the recording medium. As another example, versions of title or portions thereof associated with different languages may be recorded on the recording medium. As a still further example, a director's version and a theatrical version of a title may be recorded on the recording medium. Or, an adult version, young adult version and young child version (i.e., different parental control versions) of a title or portions of a title may be recorded on the recording medium. Each version represents a different reproduction path, and the video data in these instances is referred to as multiple reproduction path video data. It will be appreciated that the above examples of multiple reproduction path video data are not limiting, and the present invention is applicable to any type or combination of types of multiple reproduction path video data. As will be described in detail below with respect to embodiments of the present invention, the data structures according to the present invention include path management information and/or navigation information for managing reproduction of multiple reproduction path video data recorded on the recording medium.

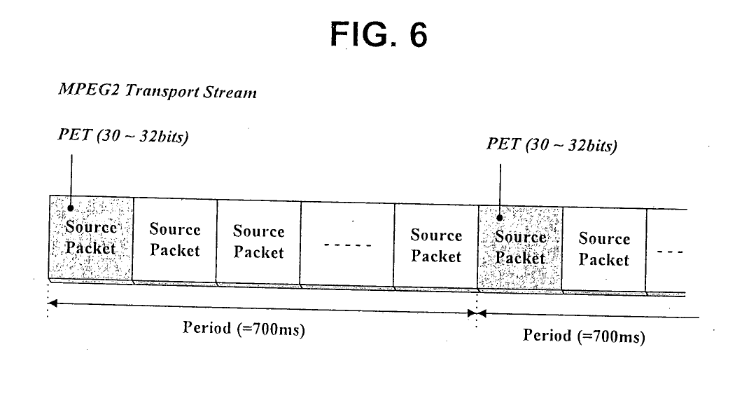

FIG. 5 illustrates a schematic diagram of an embodiment of an optical disk recording and reproducing apparatus according to the present invention. As shown, an AV encoder 9 receives and encodes audio and video data. The AV encoder 9 outputs the encoded audio and video data along with coding information and stream attribute information. A multiplexer 8 multiplexes the encoded audio and video data based on the coding information and stream attribute information to create, for example, an MPEG-2 transport stream. A source packetizer 7 packetizes the transport packets from the multiplexer 8 into source packets in accordance with the audio/video format of the optical disk. As shown in FIG. 5, the operations of the AV encoder 9, the multiplexer 8 and the source packetizer 7 are controlled by a controller 10. The controller 10 receives user input on the recording operation, and provides control information to AV encoder 9, multiplexer 8 and the source packetizer 7. For example, the controller 10 instructs the AV encoder 9 on the type of encoding to perform, instructs the multiplexer 8 on the transport stream to create, and instructs the source packetizer 7 on the source packet format. The controller 10 further controls a drive 3 to record the output from the source packetizer 7 on the optical disk.

The controller 10 also creates the navigation and management information for managing reproduction of the audio/video data being recorded on the optical disk. For example, based on information received via the user interface (e.g., instruction set saved on disk, provided over an intranet or internet by a computer system, etc.) the controller 10 controls the drive 3.

During reproduction, the controller 10 controls the drive 3 to reproduce this data structure. Based on the information contained therein, as well as user input received over the user interface (e.g., control buttons on the recording and reproducing apparatus or a remote associated with the apparatus), the controller 10 controls the drive 3 to reproduce the audio/video source packets from the optical disk. For example, the user input may specify a path to reproduce. This user input may be specified, for example, via a menu based graphical user interface preprogrammed into the controller 10. Using the user input and the path management information reproduced from the optical disk, the controller 10 controls the reproduction of the specified path.

For example, to select a particular path, the path numbers for each playlist are examined by the controller 10 to determine the number of reproduction paths, and the user is requested which path to reproduce. The path management information may be augmented to provide more meaningful information regarding the reproduction path to reproduce. During reproduction, the EP map for the selected path is accessed to perform reproduction. And, as discussed above, if the user changes the reproduction path during reproduction, a seamless change takes place by using the EP map of the new reproduction path that is aligned in time with the EP map of the old reproduction path.

The reproduced source packets are received by a source depacketizer 4 and converted into a data stream (e.g., an MPEG-2 transport packet stream). A demultiplexer 5 demultiplexes the data stream into encoded video and audio data. An AV decoder 6 decodes the encoded video and audio data to produce the original audio and video data that was feed to the AV encoder 9. During reproduction, the controller 10 controls the operation of the source depacketizer 4, demultiplexer 5 and AV decoder 6. The controller 10 receives user input on the reproducing operation, and provides control information to AV decoder 6, demultiplexer 5 and the source packetizer 4. For example, the controller 10 instructs the AV decoder 9 on the type of decoding to perform, instructs the demultiplexer 5 on the transport stream to demultiplex, and instructs the source depacketizer 4 on the source packet format.

While FIG. 5 has been described as a recording and reproducing apparatus, it will be understood that only a recording or only a reproducing apparatus may be provided using those portions of FIG. 5 providing the recording or reproducing function.

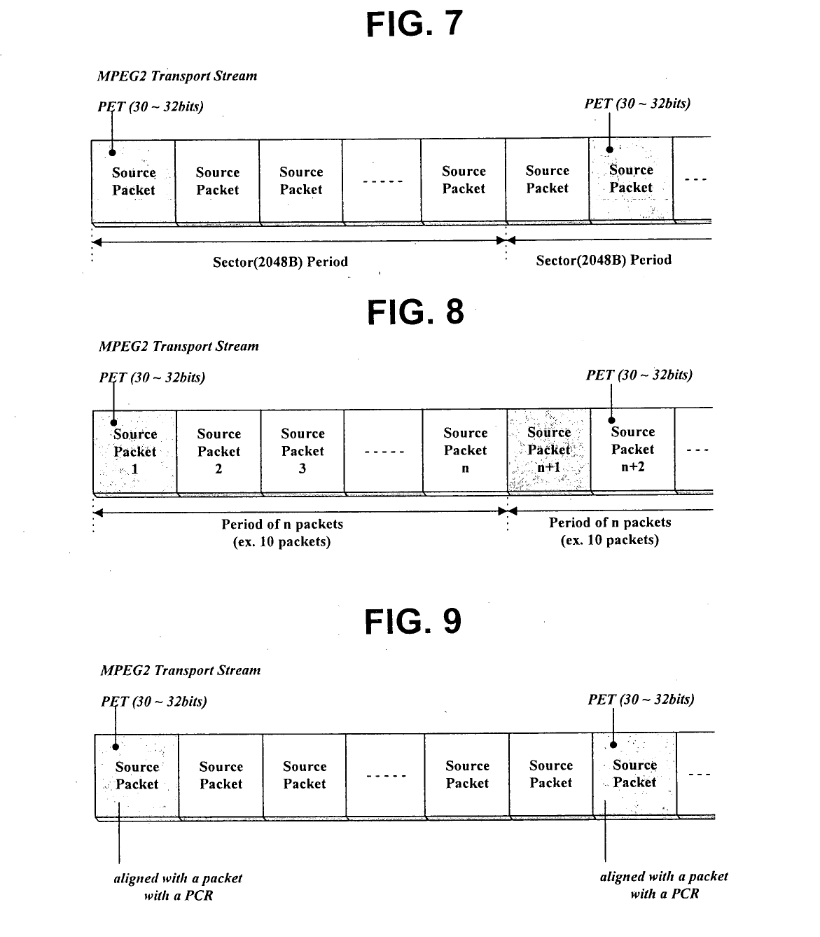

FIGS. 6 through 9 illustrate exemplary embodiments of a data structure showing a data stream having a packet encoding time stamp recorded at various intervals in the MPEG2 Transport Stream in accordance with the present invention.

FIG. 6 shows a first exemplary embodiment of the present invention. The MPEG2 Transport Stream has a plurality of source packets divided in periods not greater than 700 milliseconds. The PET is recorded in a source packet within each period. The PET's recording size is between 30 to 32 bits. In the embodiment of FIG. 6, the PET is recorded in the first source packet within each of the periods. However the PET may be recorded within an arbitrary source packet within the defined period.

FIG. 7 shows the second exemplary embodiment of the present invention. There, the PET is recorded into a source packet of a defined period where the period is of a fixed recording size. For example, the illustrated embodiment shows a MPEG2 Transport Stream with a plurality of source packets divided into sector periods of a fixed recording size. In one embodiment, the Sector period has a recording size of 2048 bytes.

In this case, the PET is either recorded into a leading source packet of the corresponding sector, or into an arbitrary source packet within the corresponding sector.

As the third exemplary embodiment of the present invention as illustrated in FIG. 8, the PET can be recorded into a source packet at an interval of fixed number of source packets. In the MPEG2 Transport Stream, each of the plurality of source packets are divided into periods of a fixed number of packets. In the illustrated example, the interval is a period of 10 packets, but other numbers may be used to define the interval.

As the fourth exemplary embodiment of the present invention, the PET can be recorded into a corresponding source packet, where the beginning of an interval occurs with a source packet aligned with program clock reference “PCR” information, as illustrated in FIG. 9.

The program clock reference is a control mechanism. The PCR is a 27-MHz reference signal generated in the multiplexer. At least 10 times a second, a sample of this clock is sent to the demultiplexer. The demultiplexer maintains its master clock, synchronized to the multiplexer clock by means of the PCR samples. The PCR is used to generate time values for the rest of the system.

In this disclosed embodiment, PET is placed in a source packet aligned with a PCR. Thus, in the illustrated MPEG2 Transport Stream, the beginning of interval occurs with a source packet aligned with a PCR and ends with the last packet before the next source packet aligned with a PCR.

In addition to recording the PET in defined intervals, as described above, it may also be included and recorded into various recording fields. The detailed descriptions are as follow.

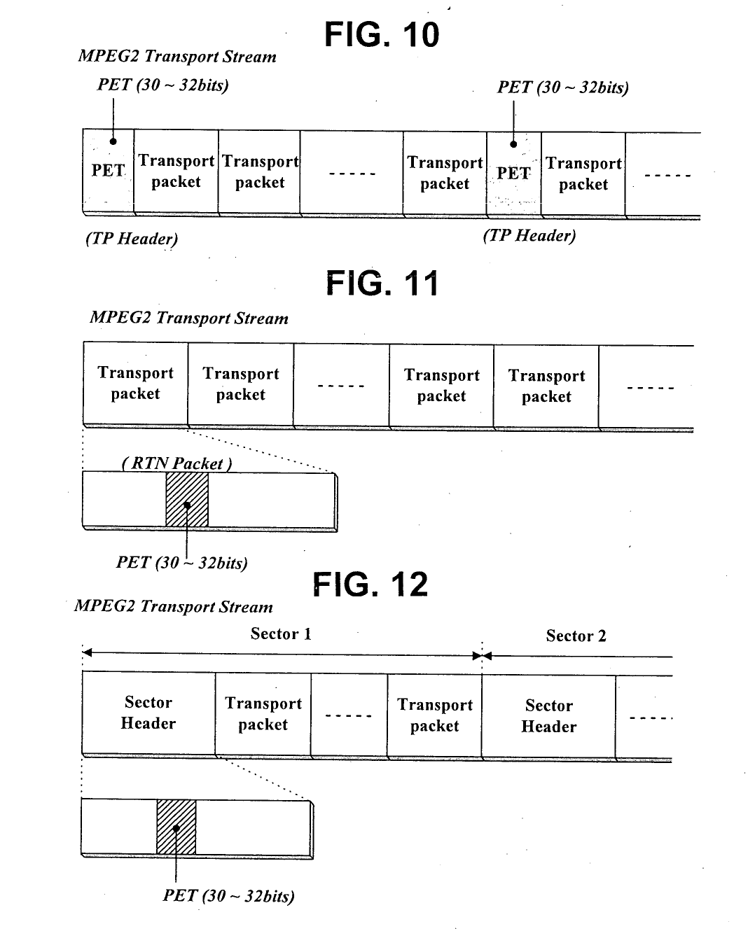

FIGS. 10 through 12 illustrate exemplary embodiments of PET in accordance with the present invention, in which PET is recorded into various recording fields.

FIG. 10 shows an exemplary embodiment of the invention where PET is recorded in an arbitrary recording field. In the illustrated MPEG2 Transport Stream, the PET is recorded in a transport packet header.

FIG. 11 shows an exemplary embodiment of the invention in which PET is recorded in another arbitrary recording field. In the illustrated MPEG2 Transport Stream, the plurality of TP's include at least some packet containing real-time navigation information. PET may be included and recorded into a certain TP that corresponds with a Real Time Navigation data Packet (hereinafter referred to simply to as RTN Packet) for controlling playback of A/V data stream.

FIG. 12 shows an exemplary embodiment of the invention in which PET is recorded in another arbitrary recording field. In the illustrated MPEG2 Transport Stream, PET can be included and recorded into each Sector Header, which has a recording size of 2048 bytes, as illustrated in FIG. 10. In the illustrated embodiment, each sector includes a sector header and at least one transport packet.

According to the above, in an optical disc apparatus like the VDP as described earlier, that A/V data stream that is extracted from the BD-ROM 20 is transmitted and outputted to an auxiliary device through a digital interface, PET gets transmitted and outputted along with the A/V data stream.

Therefore, in an auxiliary device, a normal decoding operation can be performed, since decoding time interval of the A/V data stream can be maintained with reference to the PET; decoding timing discrepancy of Source packet due to buffer overflow or buffer underflow can be prevented; and additionally, system buffer size can be reduced.

As the time information for decoding the corresponding Source packet at a fixed time interval, the PCR information can be recorded as a substitution for the PET. Moreover, separate time information that is unrelated with neither the PCR information nor PCR information can be additionally recorded into each of the Source packets as the PET.

Furthermore, the invention can prevent decoding timing discrepancy of source packet due to buffer overflow or buffer underflow, in advance; and additionally, the method can also reduce system buffer size.

Although the detailed description of the invention has been directed to certain exemplary embodiments, various modifications of these embodiments, as well as alternative embodiments, will be suggested to those skilled in the art. The invention encompasses any modifications or alternative embodiments that fall within the scope of the claims.

What is claimed is:

1. A recording medium having a data structure for managing video data recorded on the recording medium, comprising:
a plurality of data packets recorded on the recording medium;
a plurality of time control information areas, representing decoding time interval information, each of said plurality of time control information areas recorded at a fixed time interval in a corresponding one of said plurality of data packets.

2. The recording medium of claim 1, wherein said fixed time interval is not greater than 700 milliseconds.

3. A recording medium having a data structure for managing video data recorded on the recording medium, comprising:
a plurality of data packets recorded on the recording medium;
a plurality of time control information areas, representing decoding time interval information, each of said plurality of time control information areas recorded in a corresponding one of said plurality of data packets within a fixed recording area of the recording medium.

4. The recording medium of claim 3, wherein said fixed recording area is a sector.

5. The recording medium of claim 4, wherein said sector has a recording area of 2048 bytes.

6. The recording medium of claim 3, wherein each of said time control information areas is recorded in a first data packet within said fixed recording area of the recording medium.

7. The recording medium of claim 3, wherein each of said time control information areas is recorded in an arbitrary one data packet within said fixed recording area of the recording medium.

8. A recording medium having a data structure for managing video data recorded on the recording medium, comprising:
a plurality of data packets recorded on the recording medium;
a plurality of time control information areas, representing decoding time interval information, each of said plurality of time control information areas recorded in a corresponding one of said plurality of data packets within a fixed packet interval.

9. The recording medium of claim 8, wherein said fixed packet interval is 10 packets.

10. A recording medium having a data structure for managing video data recorded on the recording medium, comprising:
a plurality of data packets recorded on the recording medium;
a plurality of program reference timing control areas recording in said plurality of data packets on the recording medium;
a plurality of time control information areas, representing decoding time interval information, each of said plurality of time control information areas recorded in a corresponding one of said plurality of data packets also having one of said program reference timing control areas.

11. A method of recording a data structure for managing reproduction of video data recorded on the recording medium, comprising:
recording a plurality of data packets on the recording medium;
recording a plurality of time control information areas, representing decoding time interval information, each of said plurality of time control information areas recorded at a fixed time interval in a corresponding one of said plurality of data packets.

12. A method of reproducing a data structure for managing reproduction of video data recorded on the recording medium, comprising:
reproducing a plurality of data packets recorded on the recording medium;
reproducing a plurality of time control information areas, representing decoding time interval information, each of said plurality of time control information areas recorded at a fixed time interval in a corresponding one of said plurality of data packets.
